(19) United States
(12) Patent Application Publication
(10) Pub. No.: US 2025/0056206 A1
(43) Pub. Date: Feb. 13, 2025

(54) NF Producer Selection with Extended Subscription Data

(71) Applicant: Nokia Technologies Oy, Espoo (FI)

(72) Inventors: Joao Antonio Pereira Rodrigues, Lisbon (PT); Srinivas Garikipata, Bangalore (IN)

(21) Appl. No.: 18/796,983

(22) Filed: Aug. 7, 2024

(30) Foreign Application Priority Data
Aug. 11, 2023 (IN) 202341054124

(51) Int. Cl. H04W 8/18

(52) U.S. Cl. CPC H04W 8/186

(57) ABSTRACT

Various example embodiments disclosed herein relate to apparatuses, methods and computer programs for charging. One such example embodiment relates to a method including: receiving, by a service producer, a request from a service consumer to provide a service for a subscriber, wherein the request includes an identifier of the subscriber; inquiring, from a data repository, an indication of a service producer group the subscriber is associated with, wherein the inquiry includes the identifier of the subscriber; receiving, by the service producer in response to the requesting the indication of the service producer group the subscriber is associated with from the data repository, the indication of the service producer group; checking whether the service producer belongs to the service producer group; in response, inhibiting the service producer to provide the service for the subscriber; and informing the service consumer about the service producer group.

### TECHNICAL FIELD

Various example embodiments of the subject disclosure relate to apparatuses, methods and computer programs for charging.

### Abbreviations

3GPP 3^{rd} Generation Partnership Project
5G/6G/7G 5^{th}/6^{th}/7^{th} Generation
5GC 5G Core Network
ABMF Account Balance Management Function
AMF Access Management Function
API Application Programming Interface
AR Augmented Reality
CCS Converged Charging System
CDR Charging Data Record
CEF Charging Enablement Function
CGF Charging Gateway Function
CHF Charging Function
cNF Consumer Network Function
CTF Charging Trigger Function
EES Edge Enabler Server
HPLMN Home Public Land Mobile Network
ID Identifier
IMS IP Multimedia System
MMS Multimedia Messaging Service
MnS Management Service
NF Network Function
PCF Policy Charging Functions
PDU Protocol Data Unit
PGW Packet Network Data Gateway
PGW-C Packet Network Data Gateway-Control
PLMN Public Land Mobile Network
RF Rating Function
SBA Service-Based Architecture
SMF Session Management Function
SMSF Short Message Service Function
SUPI Subscription Permanent Identifier
NEF Network Exposure Function
NRF Network Repository Function
TS Technical Specification
UDM Unified Data Management
UDR User Data Repository
UE User Equipment
UPF User Plane Function
URLLC Ultra Reliable and Low Latency Communications
VPLMN Visiting Public Land Mobile Network
WLAN Wireless Local Area Network
XR Extended Reality

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise PLMNs operating based on radio standards (such as, those provided by 3GPP), satellite based communication systems and different wireless local networks. A wireless local network may, for example, be implemented as a WLAN. The wireless systems can typically be divided into cells, and are therefore often referred to as cellular systems.

The communication system and associated devices typically operate in accordance with a given standard or specification which sets forth what the various entities associated with the system are permitted to do and how that should be achieved. Communication protocols and/or parameters which shall be used for the connection are also typically defined. An example of a set of standards are the so-called 5G standards.

### SUMMARY

Various example embodiments of the subject disclosure aim at addressing at least part of the issue and/or problems and drawbacks either explicitly described herein or otherwise apparent to a person skilled in the relevant arts to provide methods, apparatuses and computer programs by which mechanisms and/or procedures for charging in a network can be improved.

Several aspects of the various example embodiments will be described with respect to certain aspects. These aspects are not intended to indicate key or essential features of the various example embodiments, nor are they intended to be used to otherwise limit the scope of the subject disclosure. Other features, aspects and elements of the various example embodiments will be readily apparent to a person skilled in the art in view of the subject disclosure.

According to a first aspect, there is provided an apparatus comprising:
at least one processor, and at least one memory storing instructions that, when executed by the at least one processor, cause the apparatus to perform:
receiving, by a service producer, a request from a service consumer to provide a service for a subscriber, wherein the request comprises an identifier of the subscriber;
inquiring, from a data repository, an indication of a service producer group the subscriber is associated with, wherein the inquiry comprises the identifier of the subscriber;
receiving, by the service producer in response to the requesting the indication of the service producer group the subscriber is associated with from the data repository, the indication of the service producer group the subscriber is associated with;
checking whether the service producer belongs to the service producer group the subscriber is associated with;
in response to checking that the service producer does not belong to the service producer group the subscriber is associated with:
   inhibiting the service producer to provide the service for the subscriber; and
   informing the service consumer about the service producer group the subscriber is associated with.

The identifier of the subscriber may be a subscriber permanent identifier.

The data repository may be a user data repository, and the identifier of the service producer group may be received as part of subscription data of the subscriber.

The instructions, when executed by the at least one processor, may further cause the apparatus to perform
monitoring whether the request from the service consumer comprises an indication that it is intended that the service producer provides the service for the subscriber;
in response to monitoring that the request from the service consumer comprises the indication that it is intended that the service producer provides the service for the subscriber:
   inhibiting the inquiring the indication of the service provider group from the data repository and the checking whether the service producer belongs to the service producer group the subscriber is associated with; and
   instructing the service provider to provide the service for the subscriber.

According to a second aspect, there is provided an apparatus comprising:
at least one processor, and at least one memory storing instructions that, when executed by the at least one processor, cause the apparatus to perform:
receiving, in response to requesting a service for a first subscriber from a first service producer, an identifier of a service producer group;
selecting a second service producer such that, in a received discovery response, an identifier of the second service producer is associated with an identifier of the service producer group, wherein the discovery response comprises plural identifiers of service producers including an identifier of the first service producer and an identifier of the second service producer, and each of the plural identifiers of the service producers is associated with an identifier of a respective service producer group;
requesting the service for the first subscriber from the second service producer.

The instructions, when executed by the at least one processor, may further cause the apparatus to perform
requesting a repository function for identifiers of one or more service producers capable of providing the service for the first subscriber;
receiving the discovery response in response to the requesting the repository function.

The instructions, when executed by the at least one processor, may further cause the apparatus to perform
selecting the second service producer for each session of the first subscriber without requesting the repository function for identifiers of one or more service producers capable of providing the service for the first subscriber until a timer expires;
inhibiting to select the second service producer for a session of the first subscriber without requesting the repository function for identifiers of one or more service producers capable of providing the service for the first subscriber when the timer has expired.

The request for the service for the first subscriber may comprise
a subscriber group identifier indicating that the first subscriber belongs to a subscriber group,
a request for the service for a second subscriber different from the first subscriber may comprise the subscriber group identifier; and the instructions, when executed by the at least one processor, may further cause the apparatus to perform
selecting the second service producer for a session of the second subscriber without requesting the repository function for identifiers of one or more service producers capable of providing the service for the second subscriber.

The instructions, when executed by the at least one processor, may further cause the apparatus to perform
selecting the first service producer based on the discovery response;
requesting the service for the first subscriber from the first service producer.

The instructions, when executed by the at least one processor, may further cause the apparatus to perform
the selecting the first service producer without taking into account the identifier of the service producer group associated with the identifier of the first service producer.

Each of the requests for the service may comprise a subscriber permanent identifier of the first subscriber.

The instructions, when executed by the at least one processor, may further cause the apparatus to perform
indicating, to the second service producer along with the requesting the service for the first subscriber from the second service producer, that it is intended that the second service producer provides the service for the first subscriber.

According to a third aspect, there is provided an apparatus comprising:
at least one processor, and at least one memory storing instructions that, when executed by the at least one processor, cause the apparatus to perform:
receiving a request to provide subscription data for a subscriber, wherein the request comprises an identifier of the subscriber;
retrieving, from a data repository, an identifier of a service producer group associated with the identifier of the subscriber;
providing the identifier of the service producer group in response to the request to provide the subscription data.

The request may request to provide service subscription data for the subscriber.

The identifier of the subscriber may be a subscriber permanent identifier.

According to a fourth aspect, there is provided a method comprising:
receiving, by a service producer, a request from a service consumer to provide a service for a subscriber, wherein the request comprises an identifier of the subscriber;
inquiring, from a data repository, an indication of a service producer group the subscriber is associated with, wherein the inquiry comprises the identifier of the subscriber;
receiving, by the service producer in response to the requesting the indication of the service producer group the subscriber is associated with from the data repository, the indication of the service producer group the subscriber is associated with;
checking whether the service producer belongs to the service producer group the subscriber is associated with;
in response to checking that the service producer does not belong to the service producer group the subscriber is associated with:
   inhibiting the service producer to provide the service for the subscriber; and
   informing the service consumer about the service producer group the subscriber is associated with.

The identifier of the subscriber may be a subscriber permanent identifier.

The data repository may be a user data repository, and the identifier of the service producer group may be received as part of subscription data of the subscriber.

The method may further comprise:
monitoring whether the request from the service consumer comprises an indication that it is intended that the service producer provides the service for the subscriber;
in response to monitoring that the request from the service consumer comprises the indication that it is intended that the service producer provides the service for the subscriber:
   inhibiting the inquiring the indication of the service provider group from the data repository and the checking whether the service producer belongs to the service producer group the subscriber is associated with; and
   instructing the service provider to provide the service for the subscriber.

According to a fifth aspect, there is provided a method comprising:
receiving, in response to requesting a service for a first subscriber from a first service producer, an identifier of a service producer group;
selecting a second service producer such that, in a received discovery response, an identifier of the second service producer is associated with an identifier of the service producer group, wherein the discovery response comprises plural identifiers of service producers including an identifier of the first service producer and an identifier of the second service producer, and each of the plural identifiers of the service producers is associated with an identifier of a respective service producer group;
requesting the service for the first subscriber from the second service producer.

The method may further comprise:
requesting a repository function for identifiers of one or more service producers capable of providing the service for the first subscriber;
receiving the discovery response in response to the requesting the repository function.

The method may further comprise:
selecting the second service producer for each session of the first subscriber without requesting the repository function for identifiers of one or more service producers capable of providing the service for the first subscriber until a timer expires;
inhibiting to select the second service producer for a session of the first subscriber without requesting the repository function for identifiers of one or more service producers capable of providing the service for the first subscriber when the timer has expired.

The request for the service for the first subscriber may comprise
a subscriber group identifier indicating that the first subscriber belongs to a subscriber group,
a request for the service for a second subscriber different from the first subscriber may comprise the subscriber group identifier; and the method may further comprise
selecting the second service producer for a session of the second subscriber without requesting the repository function for identifiers of one or more service producers capable of providing the service for the second subscriber.

The method may further comprise:
selecting the first service producer based on the discovery response;
requesting the service for the first subscriber from the first service producer.

The selecting the first service producer may be performed without taking into account the identifier of the service producer group associated with the identifier of the first service producer.

Each of the requests for the service may comprise a subscriber permanent identifier of the first subscriber.

The method may further comprise:
indicating, to the second service producer along with the requesting the service for the first subscriber from the second service producer, that it is intended that the second service producer provides the service for the first subscriber.

According to a sixth aspect, there is provided a method comprising:
receiving a request to provide subscription data for a subscriber, wherein the request comprises an identifier of the subscriber;
retrieving, from a data repository, an identifier of a service producer group associated with the identifier of the subscriber;
providing the identifier of the service producer group in response to the request to provide the subscription data.

The request may request to provide service subscription data for the subscriber.

The identifier of the subscriber may be a subscriber permanent identifier.

According to each of the first to sixth aspects, the service may comprise a charging service; the service producer may comprise a charging function; and the service producer group may comprise a charging function group.

Each of the methods of the fourth to sixth aspects may be a method of NF producer selection, in particular: of CHF selection.

According to a seventh aspect, there is provided a computer program product comprising a set of instructions which, when executed on an apparatus, is configured to cause the apparatus to carry out the method according to any of the fourth to sixth aspects. The computer program product may be embodied as a computer-readable medium or directly loadable into a computer.

According to some example embodiments, at least one of the following advantages may be achieved:
It is ensured that the intended CHF may be used for the subscriber;
latency may be reduced;
Consumers of NF services provided by a CHF (in particular: of NChf service (a charging service)) need not to find out the correct (intended) CHF;
The same applies to other services, where the service producers may be grouped, and a group may be associated to the subscriber.

### BRIEF DESCRIPTION OF THE DRAWINGS

In the following, some example embodiments will be described in greater detail, by way of non-limiting and illustrative example, with reference to the accompanying drawings, where:

FIG. 1 shows a charging architecture according to 3GPP TS 32.240;

FIG. 2 shows a message flow according to some example embodiments;

FIG. 3 shows an apparatus according to an example embodiment;

FIG. 4 shows a method according to an example embodiment;

FIG. 5 shows an apparatus according to an example embodiment;

FIG. 6 shows a method according to an example embodiment;

FIG. 7 shows an apparatus according to an example embodiment;

FIG. 8 shows a method according to an example embodiment; and

FIG. 9 shows an apparatus according to an example embodiment.

### DETAILED DESCRIPTION

In the following, certain example embodiments are described in detail with reference to the accompanying drawings, where the features of the example embodiments can be freely combined with each other unless otherwise described. However, it is to be expressly understood that the description of certain example embodiments is provided by way of non-limiting and illustrative example only, and that it is by no way intended to be understood as limiting.

The terminology used herein is generally provided for the purpose of describing certain example embodiments only and is not intended to be limiting. In the following, all technical and scientific terms used herein may have the same meaning as commonly understood by one of ordinary skill in the art to which this subject disclosure pertains, unless otherwise defined.

References in the subject disclosure to “an example embodiment,” “some example embodiments,” “certain example embodiments,” “various example embodiments,” and the like indicate that the referenced embodiment(s) described may include particular feature(s), structure(s), or characteristic(s), but it is not necessary that every example embodiment described herein includes the particular feature(s), structure(s), or characteristic(s). Moreover, such phrases are not necessarily referring to the same example embodiment. Further, when particular feature(s), structure(s), or characteristic(s) are described in connection with an example embodiment, it is submitted that it is within the knowledge of one skilled in the art to combine such feature(s), structure(s), or characteristic(s) in connection with any other example embodiments described herein, whether or not such combination is explicitly described.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

Moreover, it is to be understood that the apparatus is configured to perform the corresponding method, although in some cases only the apparatus or only the method are described.

Before describing in detail the various example embodiments, certain facets of a 5G wireless communication system are briefly explained.

In a non-roaming scenario, SMF may select the CHF instance at the PDU Session establishment, based on the following priorities (see 3GPP TS 32.255, clause 5.1.8):
CHF address(es) with possible associated CHF instance ID(s) and/or CHF set ID(s) provided by the PCF for the PDU session.
UDM provided charging characteristics.
NRF based discovery.
SMF locally provisioned charging characteristics.

The same applies in a roaming case to V-SMF for the selection of the CHF in VPLMN in a home routed scenario. For the CHF selection in HPLMN, V-SMF may not take into account CHF addresses provided by PCF, UDM provided charging characteristics, and SMF locally provisioned charging characteristics, but only NRF based discovery.

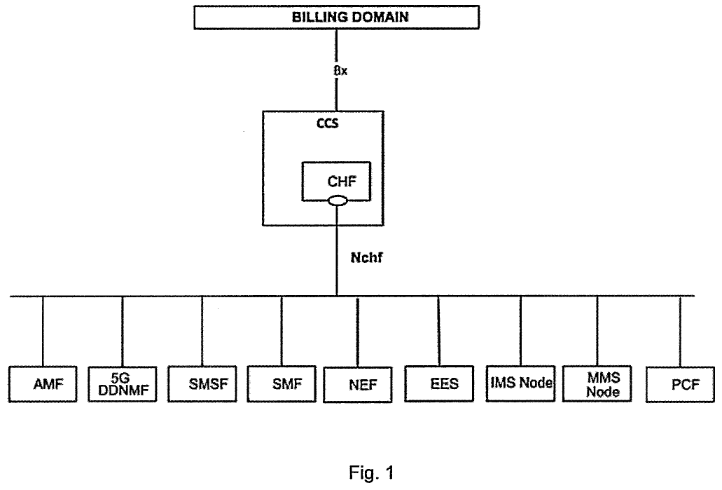

SMF is an example of a consumer of CHF. Other consumers of CHF may be SMF, SMSF, AMF, SMF+PGW-C, NEF, IMS-Node, MMS-node, CEF, MnS producer, or a EES. FIG. 1 shows a logical ubiquitous charging architecture according to 3GPP TS 32.240. The consumers of CHF communicate with CHF (which is a part of the CCS) via the Nchf-interface. Other components of the CCS are ABMF, CGF, and RF. CHF is connected (via CGF (not shown in FIG. 1) and Bx interface) with the billing domain. The CHF may include an Online Charging Function (OCF) providing quota management functionality under Credit-Control terminology and/or a Charging Data Function (CDF) providing CDRs generation functionality for charging events received from the CTF or CEF via Nchf interface.

CHF provides the services indicated in Table 1. Table 1 includes also a list of example consumers for each of the services.

TABLE 1
NF services provided by CHF

| | Service | Operation | Example |
|---|---|---|---|
| Service Name | Operations | Semantics | Consumer(s) |
| Nchf_ConvergedCharging | Create | Request/ | SMF, SMSF, |
| | | Response | AMF, |
| | | | SMF + PGW-C, |
| | | | NEF, IMS- |
| | | | Node, MMS- |
| | | | Node, CEF, |
| | | | MnS Producer, |
| | | | EES |
| | Update | Request/ | SMF, |
| | | Response | SMF + PGW-C, |
| | | | IMS-Node |
| | Release | Request/ | SMF, SMSF, |
| | | Response | AMF, NEF, |
| | | | SMF + PGW-C, |
| | | | IMS-Node, |
| | | | MMS-Node, |
| | Notify | Notify | SMF, |
| | | | SMF + PGW-C, |
| | | | IMS-Node |

CHFs may be grouped into CHF groups. For example, a CHF group may be associated with enterprise customers or with customers of specific branches of the operator to provide charging of these subscribers. In UDM/UDR, a CHF group may be associated with each subscriber or group of subscribers.

Currently SUPI is used for NRF based discovery of CHF. The CHF discovery mechanism does not support discovery of a CHF by the NF consumers like the SMF, the AMF, the SMSF and the PCF based on information about network segments that the CHF belongs to. For example:
In a network deployment it may be possible that group(s) of CHF(s) is deployed for supporting charging of enterprise customers.
It may be also possible to deploy group(s) of CHF(s) to support charging for customers belonging to specific branches of the operator.
There is a clear benefit to select a CHF which is the one closer to the UE, and in case there is an Edge infrastructure then the CHF should be the one in the Edge infrastructure.

If a network comprises plural CHFs, cNF should use a CHF associated with the subscriber by the CHF group. In 3GPP Rel-17, the CHF can register with the NRF using CHF-Group-ID (along with other parameters such as CHF-Hostname, IP Address etc.). NF consumers can use CHF-Group-ID during CHF discovery process through the NRF.

Nevertheless, the current mechanism is not sufficient to ensure that a subscriber is served by the CHF of the CHF group associated with the subscriber for the following reasons:
Some NF consumers of the CHF, the one listed in the Table 1, do not have CHF-Group-ID information associated with UE.
Group ID Mapping stored in UDR is not accessible to all NF consumers (e.g. SMSF, CEF, MnS Producer, EES etc.).
It would require that the UDR stores/maintains the mapping of the subscribers in the network to the respective CHF-Group-ID, to be able to have the right CHF belonging to the right Group-ID serve its subscriber.

In view of these restrictions, one could consider to implement a specific mechanism for each type of NF consumer to identify a correct CHF for the UE based on the CHF group. However, it is not recommended, for certain use cases, that each of the CHF consumer implements business logic to identify the correct CHF. Instead, it is recommended, for certain use cases, that CHF is self-contained and identifies the correct CHF by itself. Some example embodiments provide such a business logic which may be applicable to any type of CHF consumer, or may be restricted to some types of CHF consumers only.

Some example embodiments are described at greater detail hereinafter:

According to some example embodiments, ChfSubsriptionData are maintained at UDM/UDR. Thus, service consumers of UDM and UDR may fetch the ChfSubscriptionData which comprise at least the CHF Group ID. The ChfSubscriptionData may be stored in UDM/UDR for a group of UEs or per individual UE, for example in the same way as other SubscriptionData are maintained in the UDM/UDR.

This additional field in UDM/UDR may be defined in 3GPP TS 29.503 (Unified Data Management Services; Stage 3) and 3GPP TS 29.505 (Usage of the Unified Data Repository services for Subscription Data; Stage 3). Table 2 shows an example definition of ChfSubscriptionData.

TABLE 2
Example definition of ChfSubscriptionData

| Attribute name | Data type | P | Cardinality | Description |
|---|---|---|---|---|
| ChfGroupID | NfGroupId | C | 0 . . . 1 | CHF instances that belong to the CHF |
| | | | | Group Id that would serve the specific UE or |
| | | | | a group of UEs defined by the group |

According to some example embodiments, Nudr interface (defined by 3GPP TS 29.505) allows CHF to retrieve data from UDM/UDR. CHF may fetch the ChfSubscriptoinData for each of UE.

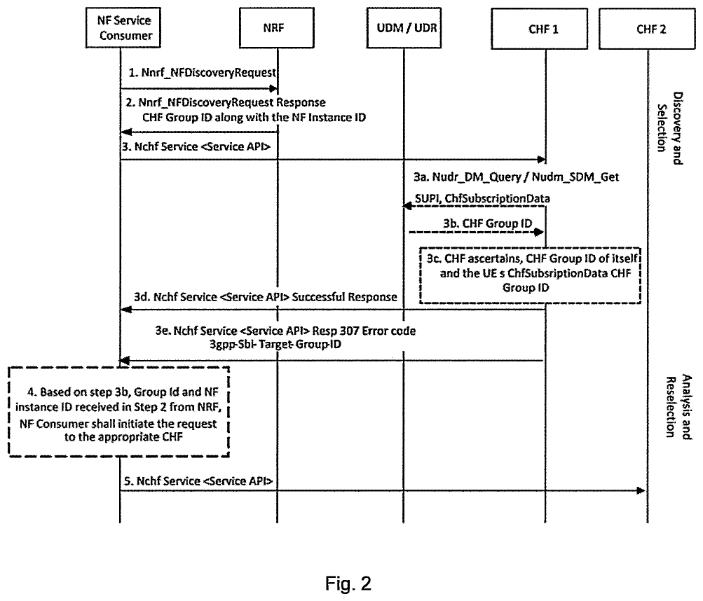

FIG. 2 shows a message sequence chart according to some example embodiments. The actions in FIG. 2 are as follows:
1. A NF Service Consumer (of any type) would like to access the Nchf service of a CHF for a subscriber (UE). Therefore, the NF service consumer sends a discovery request to NRF to discover the appropriate CHF. The discovery request comprises SUPI of the subscriber as one of the query parameters.
2. As part of the discovery response, NRF provides a list of IDs of one or more CHFs that match the discovery criteria. The discovery response includes the respective CHF Group ID for each of the CHFs. Hereinafter, it is assumed that the discovery response comprises IDs of plural CHFs belonging to at least two different CHF groups.
3. The NF Service Consumer selects one CHF ID (CHF1 in the example of FIG. 2) and invokes the Nchf Service API towards the selected CHF (CHF1), thus requesting the Nchf Service from the selected CHF. The service request comprises the SUPI of the subscriber.
   3a. Upon receipt of the service request (action 3) from the NF service consumer, the NF Service Producer (CHF1) queries UDM/UDR requesting the ChfSubsrciptionData for the corresponding SUPI.
   3b. In response to the query (action 3a) from CHF1, UDM/UDR provides to CHF1 the CHF Group ID as part of the ChfSubscriptionData.
   3c. CHF1 checks whether the CHF group ID received from UDM/UDR is the same as one of its own CHF group IDs.
   3d. If the CHF1 checks that the CHF group ID received from UDM/UDR is the same as one of its own CHF group IDs, CHF1 knows that it is an appropriate CHF to provide the NChf Service to the subscriber identified by SUPI. Accordingly, it processes the service request and responds to the NF Service Consumer.
   3e. If the CHF1 checks that the CHF group ID received from UDM/UDR is not the same as any of its own CHF group IDs, CHF1 knows that it is not an appropriate CHF to provide the NChf Service to the subscriber identified by SUPI. Accordingly, CHF1 responds to the service request (action 3) from the NF Service Consumer providing the CHF group ID received from UDM/UDR in action 3b (the CHF group ID of the SUPI). Typically, the response may comprise an error code (e.g. 307). The CHF Group ID of the SUPI and the error code, if any, may be part of the header of the response message.

Actions 4 and 5 follow after action 3e but not after action 3d, i.e. in case that the CHF1 checks that the CHF group ID received from UDM/UDR is not the same as any of its own CHF group IDs.
4. NF Service Consumer, based on the discovery result received from NRF in action 2 and the CHF Group ID of the SUPI received from CHF1 in action 3e, reselects another CHF (CHF2 in the example of FIG. 2). In more detail, NF Service Consumer selects one of the CHFs (e.g. CHF2) comprised in the list of CHFs received in the discovery response from NRF (action 2) such that the CHF group ID associated to that CHF ID in the discovery response is the same as the CHF group ID received in the response from CHF1 in action 3e.
5. NF Service Consumer invokes the Nchf Service API towards the selected CHF2 requesting to provide the Nchf Service for the subscriber identified by the SUPI. Action 5 towards CHF2 corresponds to Action 3 towards CHF1.

Then, NF Service Consumer may use CHF2 for the subsequent Nchf service requests for the subscriber identified by the SUPI.

For the selection of the alternative CHF (CHF2, action 4 in FIG. 2), NF service consumer may take into account other parameters, such as NF set, in addition to CHF group ID.

In some example embodiments, an expiry timer may be associated with the CHF group ID for the subscriber received from CHF1. For example, the timer may be provided by UDM/UDR and forwarded, via CHF1 to the NF service consumer, or the timer may be started at the NF service consumer when NF service consumer receives the CHF group ID from CHF1 (action 3e). The duration until the timer expires may be predefined or provided by UDM/UDR to NF service consumer (via CHF1). NF service consumer may select CHF2 for different sessions of the subscriber until the timer expires. Then, NF service consumer may run the same procedure as shown in FIG. 2 again.

The request for providing the charging service may comprise a group ID indicating that the subscriber belongs to a subscriber group. If the same group ID is indicated in a request for the charging service for another subscriber, the CHF finally selected for the first subscriber (CHF2 in the example of FIG. 2) may be used for the other subscriber, too.

In some example embodiments, the NF service consumer may, when it requests the Nchf service for a second time (action 5 of FIG. 2) while the NF service consumer knows that this second request is towards the intended CHF for the subscriber, indicate this knowledge in the service request, e.g. by setting a corresponding flag. Thus, when CHF2 receives the Nchf service request of action 5 including the indication that CHF2 is an intended CHF for the subscriber (e.g. the set flag), CHF2 need not to check again, with the help of UDM/UDR, whether or not CHF2 is an intended CHF for the subscriber.

Table 3 shows the CDR request message attributes according to some example embodiments. For example, these CDR message attributes may be defined by 3GPP TS 32.255, Table 6.1.1.2.1.

TABLE 3
CDR request message attributes according to some example embodiments

| | Category | | |
|---|---|---|---|
| | for | Category for | |
| | converged | offline only | |
| Information Element | charging | charging | Description |
| Session Identifier | O_{C} | O_{C} | Described in TS 32.290 [57] |
| Subscriber Identifier | O_{M} | M | Described in TS 32.290 [57] |
| | | | In case SUPI is not present (for |
| | | | emergency service), the User |
| | | | Equipment Info in table 6.2.1.2.1. |
| | | | shall be present for identifying the |
| | | | user. |
| NF Consumer Identification | M | M | Described in TS 32.290 [57] |
| NF Functionality | M | O_{C} | Described in TS 32.290 [57] |
| NF Name | O_{C} | O_{C} | Described in TS 32.290 [57] |
| NF Address | O_{C} | O_{C} | Described in TS 32.290 [57] |
| NF PLMN ID | O_{C} | O_{C} | Described in TS 32.290 [57] |
| Invocation Timestamp | M | M | Described in TS 32.290 [57] |
| Invocation Sequence | M | M | Described in TS 32.290 [57] |
| Number | | | |
| Retransmission Indicator | O_{C} | O_{C} | Described in TS 32.290 [57] |
| Notify URI | O_{C} | O_{C} | Described in TS 32.290 [57] |
| CHF Group | O_{C} | — | CHF instances that belong to the |
| | | | CHF Group Id that would serve the |
| | | | specific UE or a group of UEs |
| | | | defined by the group |
| CHF Group Priority | O_{C} | — | CHF Instance priority withing a |
| | | | group for selection |
| Service Specification | O_{C} | O_{C} | Described in TS 32.290 [57] |
| Information | | | |
| Supported Features | O_{C} | — | This field indicates the features |
| | | | supported by the NF consumer. |
| Triggers | O_{C} | O_{C} | Extend the trigger default rules |
| | | | which would allow the event |
| | | | charging by a specific CHF |
| | | | Instance from a CHF Group |
| | | | This field is described in TS 32.290 |
| | | | [57] and holds the 5G data |
| | | | connectivity specific triggers |
| | | | described in clause 5.2.1. |
| Multiple Unit Usage | O_{C} | O_{C} | Described in TS 32.290 [57] |
| | | | This field is not applicable to QBC. |
| Rating Group | M | M | Described in TS 32.290 [57] |
| Requested Unit | O_{C} | — | Described in TS 32.290 [57] |
| Used Unit Container | O_{C} | O_{C} | Described in TS 32.290 [57] |
| Triggers | O_{C} | O_{C} | This field is described in TS 32.290 |
| | | | [57] and holds the 5G data |
| | | | connectivity specific triggers |
| | | | described in clause 5.2.1. |
| PDU Container Information | O_{C} | O_{C} | This field holds the 5G data |
| | | | connectivity PDU session |
| | | | container specific information |
| | | | described in clause 6.2. |
| UPF ID | O_{C} | O_{C} | This field holds the UPF identifier |
| | | | used to identify the UPF. |
| | | | These fields shall only be included |
| | | | when either quota is requested per |
| | | | UPF, or used units are reported |
| | | | per UPF |
| multi-homed PDU address | O_{C} | O_{C} | This field holds the IPv6 prefix |
| | | | used by UPF. It may only be used |
| | | | for IPv6 multi-homed PDU |
| | | | sessions and then only for |
| | | | reporting used units. |
| PDU Session Charging | O_{M} | O_{M} | This field holds the 5G data |
| Information | | | connectivity specific information |
| | | | described in clause 6.2. |
| | | | This field is applicable to FBC and |
| | | | QBC. |
| Roaming QBC information | O_{M} | O_{M} | This field holds the roaming QBC |
| | | | specific information defined in |
| | | | clause 6.2.1.4 |
| | | | This field is only applicable to |
| | | | QBC. |

Table 4 shows the CDR response message attributes according to some example embodiments. For example, these CDR message attributes may be defined by 3GPP TS 32.255, Table 6.1.1.2.2.

TABLE 4
CDR response message attributes according to some example embodiments

| | | Category | |
|---|---|---|---|
| | Category for | for offline | |
| | converged | only | |
| Information Element | charging | charging | Description |
| Session Identifier | O_{C} | O_{C} | Described in TS 32.290 [57] |
| Invocation Timestamp | M | M | Described in TS 32.290 [57] |
| Invocation Result | O_{C} | M | Described in TS 32.290 [57] |
| Invoation Result Code | O_{C} | M | Described in TS 32.290 [57] |
| Failed Parameter | O_{C} | O_{C} | Described in TS 32.290 [57] |
| Failure Handling | O_{C} | O_{C} | Described in TS 32.290 [57] |
| Invocation Sequence | M | M | Described in TS 32.290 [57] |
| Number | | | |
| Session Failover | O_{C} | O_{C} | Described in TS 32.290 [57] |
| Supported Features | O_{C} | — | This field indicates the features supported |
| | | | by the NF consumer. |
| Multiple Unit Information | O_{C} | O_{C} | Described in TS 32.290 [57] |
| | | | This field is not applicable to QBC. |
| Result Code | O_{C} | O_{C} | Described in TS 32:290 [57] |
| Rating Group | M | M | Described in TS 32.290 [57] |
| UPF ID | O_{C} | O_{C} | This field holds the UPF identifier used for |
| | | | quota granted per UPF by CHF |
| Granted Unit | O_{C} | — | Described in TS 32.290 [57] |
| Validity Time | O_{C} | — | Described in TS 32.290 [57] |
| Final Unit Indication | O_{C} | — | Described in TS 32.290 [57] |
| Time Quota Threshold | OC | — | Described in TS 32.290 [57] |
| Volume Quota Threshold | OC | — | Described in TS 32.290 [57] |
| Unit Quota Threshold | OC | — | Described in TS 32.290 [57] |
| Quota Holding Time | O_{C} | — | Described in TS 32.290 [57] |
| Triggers | O_{C} | O_{C} | This field is described in TS 32.290 [57] |
| | | | and holds the 5G data connectivity |
| | | | specific triggers described in clause 5.2.1. |
| CHF Subscription Data | O_{C} | — | CHF Instance to be used for a UE/ |
| | | | Subscriber |
| CHF Instance Response | O_{C} | — | This field with hold the response code for |
| Code | | | a the availability of a CHF Instance close |
| | | | to the UE |
| Triggers | O_{C} | O_{C} | This field is described in TS 32.290 [57] |
| | | | and holds the 5G data connectivity |
| | | | specific triggers described in clause 5.2.1. |
| PDU Session Charging | O_{M} | O_{M} | This field holds the 5G data connectivity |
| Information | | | specific information described in clause |
| | | | 6.2. |
| Roaming QBC Information | O_{M} | O_{M} | This field holds the roaming QBC specific |
| | | | information defined in clause 6.2.1.4 |
| | | | This field is not applicable to FBC. |

Hereinabove, some example embodiments are explained with respect to charging as a service, where CHF is the service producer, each CHF belongs to at least one CHF group, and a subscriber is associated to a CHF group. However, some example embodiments may be applied to another service than charging, where each of the service producers of the service belongs to at least one service producer group, and a subscriber is associated to at least one of the service producer groups.

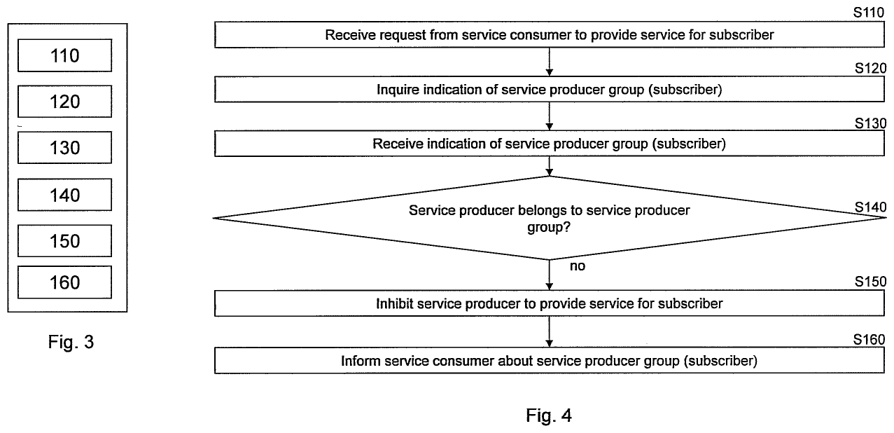

FIG. 3 shows an apparatus according to an example embodiment. In some example embodiments, the apparatus may comprise CHF functionality or be implemented as an element of a CHF. In some example embodiments, the apparatus may be configured to operate as a CHF. For instance, the apparatus may be configured to perform one or more functions of a CHF. FIG. 4 shows a method according to an example embodiment. The apparatus according to FIG. 3 may perform the method of FIG. 4 but is not limited to this method. The method of FIG. 4 may be performed by the apparatus of FIG. 3 but is not limited to being performed by this apparatus.

The apparatus comprises first means for receiving 110, means for inquiring 120, second means for receiving 130, means for checking 140, means for inhibiting 150, and means for informing 160. The first means for receiving 110, means for inquiring 120, second means for receiving 130, means for checking 140, means for inhibiting 150, and means for informing 160 may be a first receiving means, inquiring means, second receiving means, checking means, inhibiting means, and informing means, respectively. The first means for receiving 110, means for inquiring 120, second means for receiving 130, means for checking 140, means for inhibiting 150, and means for informing 160 may be a first receiver, inquirer, second receiver, checker, inhibitor, and informer, respectively. The first means for receiving 110, means for inquiring 120, second means for receiving 130, means for checking 140, means for inhibiting 150, and means for informing 160 may be a first receiving processor, inquiring processor, second receiving processor, checking processor, inhibiting processor, and informing processor, respectively.

The first means for receiving 110 receives, by a service producer (such as a charging function), a request from a service consumer to provide a service (such as a charging service) for a subscriber (S110). The request comprises an identifier of the subscriber, such as a SUPI.

The means for inquiring 120 inquires, from a data repository (such as UDM/UDR), an indication of a service producer group (such as a CHF group) the subscriber is associated with (S120). The inquiry comprises the identifier of the subscriber.

The second means for receiving 130 receives, by the service producer, the indication of the service producer group the subscriber is associated with (S130). The second means for receiving 130 receives the indication of the service producer group from the data repository in response to the requesting of the indication of the service producer group the subscriber is associated with, i.e., in response to the inquiring of S120.

The means for checking 140 checks whether the service producer belongs to the service producer group the subscriber is associated with (S140). I.e., the means for checking recognizes the service producer group(s) the service producer belongs to and compares it with the service producer group the indication of which is received in S130.

In response to checking that the service producer does not belong to the service producer group the subscriber is associated with (S140=no), the means for inhibiting 150 and the means for informing 160 act as follows:

The means for inhibiting 150 inhibits the service producer to provide the service for the subscriber (S150). The means for informing 160 informs the service consumer about the service producer group the subscriber is associated with (S160), i.e. about the service producer group received in S130.

S150 and S160 may be performed in an arbitrary sequence. They may be performed fully or partly in parallel.

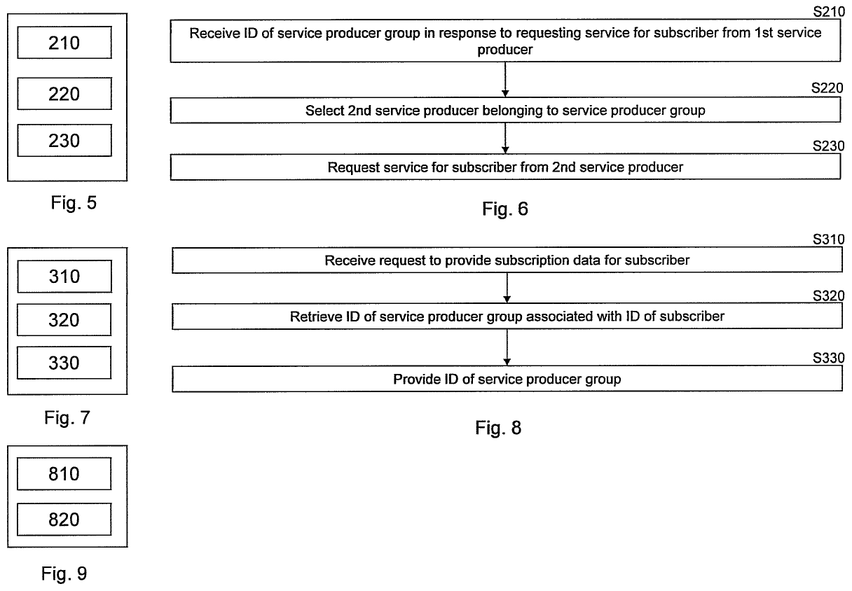

FIG. 5 shows an apparatus according to an example embodiment. In some example embodiments, the apparatus may comprise NF consumer (e.g., an NF consumer of a CHF) functionality or be implemented as an element of such an NF consumer. In some example embodiments, the apparatus may be configured to operate as an NF consumer (e.g., NF consumer of a CHF). For instance, the apparatus may be configured to perform one or more functions of an NF consumer (e.g., NF consumer of a CHF). FIG. 6 shows a method according to an example embodiment. The apparatus according to FIG. 5 may perform the method of FIG. 6 but is not limited to this method. The method of FIG. 6 may be performed by the apparatus of FIG. 5 but is not limited to being performed by this apparatus.

The apparatus comprises means for receiving 210, means for selecting 220, and means for requesting 230. The means for receiving 210, means for selecting 220, and means for requesting 230 may be a receiving means, selecting means, and requesting means, respectively. The means for receiving 210, means for selecting 220, and means for requesting 230 may be a receiver, selector, and requester, respectively. The means for receiving 210, means for selecting 220, and means for requesting 230 may be a receiving processor, selecting processor, and requesting processor, respectively.

The means for receiving 210 receives an identifier of a service producer group (such as a CHF group) (S210). The means for receiving 210 receives the identifier of the service producer group in response to requesting a service (such as a charging service) for a subscriber from a first service producer (such as a charging function).

The means for selecting 220 selects a second service producer (such as a second charging function) (S220). The means for selecting 220 selects the second service producer such that, in a received discovery response, an identifier of the second service producer is associated with an identifier of the service producer group. The discovery response may be received in response to a discovery request and comprises plural identifiers of service producers. The plural identifiers of service producers include an identifier of the first service producer and an identifier of the second service producer. Each of the plural identifiers of the service producers is associated with an identifier of a respective service producer group.

The means for requesting 230 requests the service for the subscriber from the second service producer (S230) selected in S220.

FIG. 7 shows an apparatus according to an example embodiment. In some example embodiments, the apparatus may comprise a data repository (e.g., a UDM/UDR) functionality or be implemented as an element of such a data repository. In some example embodiments, the apparatus may be configured to operate as a data repository (e.g., UDM/UDR). For instance, the apparatus may be configured to perform one or more functions of a data repository (e.g., UDM/UDR). FIG. 8 shows a method according to an example embodiment. The apparatus according to FIG. 7 may perform the method of FIG. 8 but is not limited to this method. The method of FIG. 8 may be performed by the apparatus of FIG. 7 but is not limited to being performed by this apparatus.

The apparatus comprises means for receiving 310, means for retrieving 320, and means for providing 330. The means for receiving 310, means for retrieving 320, and means for providing 330 may be a receiving means, retrieving means, and providing means, respectively. The means for receiving 310, means for retrieving 320, and means for providing 330 may be a receiver, retriever, and provider, respectively. The means for receiving 310, means for retrieving 320, and means for providing 330 may be a receiving processor, retrieving processor, and providing processor, respectively.

The means for receiving 310 receives a request to provide subscription data for a subscriber (S310). The request comprises an identifier of the subscriber.

The means for retrieving 320 retrieves, from a data repository (such as UDM/UDR), an identifier of a service producer group (such as a CHF group) associated with the identifier of the subscriber (S320).

The means for providing 330 provides the identifier of the service producer group in response to the request to provide the subscription data of S310 (S330).

FIG. 9 shows an apparatus according to an example embodiment. The apparatus comprises at least one processor 810, at least one memory 820 storing instructions that, when executed by the at least one processor 810, cause the apparatus at least to perform the method according to at least one of the following figures and related description: FIG. 4, or FIG. 6, or FIG. 8.

In some example embodiments, the at least one processor 810 may be of any type suitable to the local technical network and may include one or more of the following: general purpose computers, special purpose computers, microprocessors, digital signal processors (DSPs) and processors based on multicore processor architecture, as non-limiting and illustrative examples. The apparatus may have multiple processors, such as an application specific integrated circuit chip that is slaved in time to a clock which synchronizes the main processor.

In some example embodiments, the at least one memory 820 may include one or more non-volatile memories and one or more volatile memories. Examples of the non-volatile memories include, but are not limited to, Read Only Memory (ROM), an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, random access memory (RAM) and other volatile memories that will not last in the power-down duration.

In some example embodiments, a program (e.g., computer program) may be provided that includes executable instructions that are executed by the at least one processor 810. The instructions of program may include instructions for performing operations/acts of some example embodiments of the subject disclosure. The program may be stored in the at least one memory 820, e.g., ROM. At least one processor 810 may perform any suitable actions and processing by loading program into RAM.

The example embodiments of the subject disclosure may be implemented by means of program so that the apparatus of FIG. 9 may be configured to perform any process of the disclosure as discussed with reference to FIG. 4, or FIG. 6, or FIG. 8. The various example embodiments of the subject disclosure may also be implemented by hardware or by a combination of software and hardware.

In some example embodiments, program may be tangibly contained in a computer readable medium which may be included in the apparatus of FIG. 9 (such as, in the at least one memory 820) or other storage devices that are accessible by the apparatus. The apparatus of FIG. 9 may be configured to load the program from the computer readable medium to RAM 822 for execution. In some example embodiments, the computer readable medium may include any types of non-transitory storage medium, such as ROM, EPROM, a flash memory, a hard disk, CD, DVD, and the like.

The term “non-transitory,” as used herein, is a limitation of the medium itself (e.g., tangible, not a signal) as opposed to a limitation on data storage persistency (e.g., RAM vs. ROM).

Some example embodiments are explained with respect to 5G (NR). However, other example embodiments may be employed in other 3GPP generations, such as 4G, 6G, 7G, etc., or in other wireless or wired communication devices.

Some example embodiments are described with SUPI as an ID of a subscriber (UE). However, according to some example embodiments, another ID of the subscriber (such as MSISDN) may be used.

A UE is an example of a terminal. Other examples are MTC devices. Each of the terminals may be implemented as a smartphone, a mobile phone, a laptop, a sensor device etc. Typical terminals are cellular communication devices for communicating in a cellular network (such as a 3GPP network), but this is not mandatory.

The term “a CHF” or “a service producer” may be read as “a CHF instance” and “a service producer instance”, respectively, unless otherwise specified or made clear from the context.

One piece of information may be transmitted in one or plural messages from one entity to another entity. Each of these messages may comprise further (different) pieces of information.

Names of network elements, network functions, protocols, and methods are based on current standards. In other versions or other technologies, the names of these network elements and/or network functions and/or protocols and/or methods may be different, as long as they provide a corresponding functionality. The same applies correspondingly to the terminal.

If not otherwise stated or otherwise made clear from the context, the statement that two entities are different means that they perform different functions. It does not necessarily mean that they are based on different hardware. That is, each of the entities described in the subject disclosure may be based on a different hardware, or some or all of the entities may be based on the same hardware. It does not necessarily mean that they are based on different software. That is, each of the entities described in the subject disclosure may be based on different software, or some or all of the entities may be based on the same software. Each of the entities described in the subject disclosure may be deployed in the cloud.

According to the above description, it should thus be apparent that example embodiments provide, for example, a service producer (such as a charging function), or an element thereof, an apparatus embodying the same, a method for controlling and/or operating the same, and computer program(s) controlling and/or operating the same as well as mediums carrying such computer program(s) and forming computer program product(s).

According to the above description, it should thus be apparent that example embodiments provide, for example, a consumer of service provided by a service producer (such as a consumer of a charging service provided by a charging function (such as SMF, SMSF, AMF, SMF+PGW-C, NEF, IMS-Node, MMS-node, CEF, MnS producer, or EES)), or an element thereof, an apparatus embodying the same, a method for controlling and/or operating the same, and computer program(s) controlling and/or operating the same as well as mediums carrying such computer program(s) and forming computer program product(s).

According to the above description, it should thus be apparent that example embodiments provide, for example, a data repository (such as a UDM, a UDR, or a UDM/UDR), or an element thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting and illustrative examples, implementations as hardware, software, firmware, special purpose circuits or logic, circuitry, general purpose hardware or controller or other computing devices, or some combination thereof. Each of the entities described in the subject disclosure may be embodied in the cloud. As used herein, the term “circuitry” may refer to one or more or all of the following example embodiments:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term herein, including in any claims. As a further example embodiment, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network node, or other computing or network node.

As used herein, unless stated explicitly, performing a step “in response to A” does not indicate that the step is performed immediately after “A” occurs, and one or more intervening steps may be included between “A” and the step.

As used herein, the terms “first X” and “second X” include the options that “first X” is the same as “second X” and that “first X” is different from “second X”, unless otherwise specified. Thus, it shall be understood that although the terms “first,” “second,” and the like may be used herein to describe various elements, these elements should not be limited by these terms. These terms are only used to distinguish one element from another. For example, a first element could be termed a second element, and similarly, a second element could be termed a first element without departing from the scope of example embodiments.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. As used herein, the term “and/or” includes any and all combinations of one or more of the listed terms.

Although various example embodiments of the subject disclosure have been described in language specific to structural features and/or methodological acts, it is to be understood that the various example embodiments of the subject disclosure are not necessarily limited to the specific features or acts described above. Rather, the specific features and acts described herein are disclosed as example forms of implementing the various example embodiments of the subject disclosure.

1. An apparatus, comprising:
at least one processor, and
at least one memory storing instructions that, when executed with the at least one processor, cause the apparatus to perform:
receiving, with a service producer, a request from a service consumer to provide a service for a subscriber, wherein the request comprises an identifier of the subscriber;
inquiring, from a data repository, an indication of a service producer group the subscriber is associated with, wherein the inquiry comprises the identifier of the subscriber;
receiving, with the service producer in response to the requesting the indication of the service producer group the subscriber is associated with from the data repository, the indication of the service producer group the subscriber is associated with;
checking whether the service producer belongs to the service producer group the subscriber is associated with;
in response to checking that the service producer does not belong to the service producer group the subscriber is associated with:
inhibiting the service producer to provide the service for the subscriber; and
informing the service consumer about the service producer group the subscriber is associated with.

2. The apparatus according to claim 1, wherein the identifier of the subscriber is a subscriber permanent identifier.

3. The apparatus according to claim 1, wherein the data repository is a user data repository, and the identifier of the service producer group is received as part of subscription data of the subscriber.

4. The apparatus according to claim 1, wherein the instructions, when executed with the at least one processor, further cause the apparatus to perform,
monitoring whether the request from the service consumer comprises an indication that it is intended that the service producer provides the service for the subscriber;
in response to monitoring that the request from the service consumer comprises the indication that it is intended that the service producer provides the service for the subscriber:
inhibiting the inquiring the indication of the service provider group from the data repository and the checking whether the service producer belongs to the service producer group the subscriber is associated with; and
instructing the service provider to provide the service for the subscriber.

5. An apparatus comprising:
at least one processor, and
at least one memory storing instructions that, when executed with the at least one processor, cause the apparatus to perform:
receiving, in response to requesting a service for a first subscriber from a first service producer, an identifier of a service producer group;
selecting a second service producer such that, in a received discovery response, an identifier of the second service producer is associated with an identifier of the service producer group, wherein the discovery response comprises plural identifiers of service producers including an identifier of the first service producer and an identifier of the second service producer, and each of the plural identifiers of the service producers is associated with an identifier of a respective service producer group; and
requesting the service for the first subscriber from the second service producer.

6. The apparatus according to claim 5, wherein the instructions, when executed with the at least one processor, further cause the apparatus to perform
requesting a repository function for identifiers of one or more service producers capable of providing the service for the first subscriber; and
receiving the discovery response in response to the requesting the repository function.

7. The apparatus according to claim 6, wherein the instructions, when executed with the at least one processor, cause the apparatus to perform,
selecting the second service producer for a session of the first subscriber without requesting the repository function for identifiers of one or more service producers capable of providing the service for the first subscriber until a timer expires; and
inhibiting to select the second service producer for a session of the first subscriber without requesting the repository function for identifiers of one or more service producers capable of providing the service for the first subscriber when the timer has expired.

8. The apparatus according to claim 6, wherein,
the request for the service for the first subscriber comprises a subscriber group identifier indicating that the first subscriber belongs to a subscriber group,
a request for the service for a second subscriber different from the first subscriber comprises the subscriber group identifier; and
the instructions, when executed with the at least one processor, cause the apparatus to perform selecting the second service producer for a session of the second subscriber without requesting the repository function for identifiers of one or more service producers capable of providing the service for the second subscriber.

9. The apparatus according to claim 5, wherein the instructions, when executed with the at least one processor, further cause the apparatus to perform,
selecting the first service producer based on the discovery response; and
requesting the service for the first subscriber from the first service producer.

10. The apparatus according to claim 9, wherein the instructions, when executed with the at least one processor, cause the apparatus to perform selecting the first service producer without taking into account the identifier of the service producer group associated with the identifier of the first service producer.

11. The apparatus according to claim 5, wherein the requests for the service comprise subscriber permanent identifiers of the first subscriber.

12. The apparatus according to claim 5, wherein the instructions, when executed with the at least one processor, cause the apparatus to perform indicating, to the second service producer along with the requesting the service for the first subscriber from the second service producer, that it is intended that the second service producer provides the service for the first subscriber.

13. An apparatus, comprising:
at least one processor, and
at least one memory storing instructions that, when executed with the at least one processor, cause the apparatus to perform:
receiving a request to provide subscription data for a subscriber, wherein the request comprises an identifier of the subscriber;
retrieving, from a data repository, an identifier of a service producer group associated with the identifier of the subscriber; and
providing the identifier of the service producer group in response to the request to provide the subscription data.

14. The apparatus according to claim 13, wherein the request requests to provide service subscription data for the subscriber.

15. The apparatus according to claim 13, wherein the identifier of the subscriber is a subscriber permanent identifier.

16-34. (canceled)
